(19) United States
(12) Patent Application Publication
(10) Pub. No.: US 2021/0266191 A1
(43) Pub. Date: Aug. 26, 2021

(54) CONSUMER APPLIANCE INHERITANCE METHODS AND SYSTEMS

(71) Applicant: Haier US Appliance Solutions, Inc., Wilmington, DE (US)

(72) Inventors: Seung-Yeong Park, Youngin-si (KR); Hoyoung Lee, Youngin-si (KR)

(21) Appl. No.: 16/798,655

(22) Filed: Feb. 24, 2020

(51) Int. Cl. H04L 12/28; G06N 20/00

(52) U.S. Cl. CPC H04L 12/2814; H04L 2012/2841; G06N 20/00

(57) ABSTRACT

A consumer appliance, as provided herein, may include a cabinet, a user input, and a controller. The user input may be positioned on an exterior of the cabinet. The controller may be mounted to the cabinet. The controller may be configured to initiate an inheritance operation. The inheritance operation may include establishing a local use-based data set of the consumer appliance, storing the local use-based data set in an internal primary stack within the controller, transmitting the local use-based data set to a wirelessly-connected remote appliance, receiving a remote use-based data set from the wirelessly-connected remote appliance, and storing the remote use-based data set in an internal secondary stack within the controller.

### FIELD OF THE INVENTION

The present subject matter relates generally to consumer appliances and, more particularly, to features and methods for transferring settings of one appliance to another appliance.

### BACKGROUND OF THE INVENTION

Consumer appliances, such as refrigerator appliances, oven appliances, microwave appliances, dishwasher appliances, etc., generally include one or more components for directing operation of a given consumer appliance. For example, a consumer appliance may include a controller having a printed circuit board and memory that is connected to a control pad. Through programmed instructions and input from the control pad, the controller may work with the other components of the appliance to direct operations thereof. Some consumer appliances can also include features for connecting to and communicating over a secure wireless network. Such communication may provide connected features on the consumer appliances (e.g., where the consumer appliance communicates with a personal device, smart home systems, or a remote database such as a cloud server).

One challenge that exists with existing appliances is how to address the replacement of a particular (e.g., old) appliance with a new appliance. In particular, over time, most consumers will choose to replace at least one older model or unit for another newer model or unit, such as when a user changes refrigerators. This may occur because the old appliance has been damaged, an upgrade is desired, or any other reason—whether planned or unplanned in advance. Irrespective of why the old appliance is being replaced, a user must often set up or guide the desired operation of the new appliance. Specifically, the user must update the factory-default settings of the old appliance. Usually the settings are updated to match or mirror the settings that the user had enjoyed on the old appliance. Nonetheless, it may be difficult if not impossible for certain settings to be matched with existing appliances. For instance, if the old appliance included or was operated based on any adaptive algorithm or machine learning model, the user may be unable to readily transfer the old data, algorithm, or model from the old appliance. In turn, the new appliance would have to start from scratch and may take a great deal of time to learn the settings or patterns that were used in the old appliance.

As a result, there is a need for methods and features for transferring settings or data between one appliance and another (e.g., replacement) appliance. Additionally or alternatively, it would be advantageous to provide an appliance or method whose settings or data could be easily inherited by another appliance (e.g., without direct guidance from a user).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of operating a consumer appliance is provided. The method may include establishing a local use-based data set of the consumer appliance, and storing the local use-based data set in an internal primary stack. The method may further include transmitting the local use-based data set to a wirelessly-connected remote appliance. The method may still further include receiving a remote use-based data set from the wirelessly-connected remote appliance, and storing the remote use-based data set in an internal secondary stack.

In another exemplary aspect of the present disclosure, a consumer appliance is provided. The consumer appliance may include a cabinet, a user input, and a controller. The user input may be positioned on an exterior of the cabinet. The controller may be mounted to the cabinet. The controller may be configured to initiate an inheritance operation. The inheritance operation may include establishing a local use-based data set of the consumer appliance, storing the local use-based data set in an internal primary stack within the controller, transmitting the local use-based data set to a wirelessly-connected remote appliance, receiving a remote use-based data set from the wirelessly-connected remote appliance, and storing the remote use-based data set in an internal secondary stack within the controller.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of an appliance system according to exemplary embodiments of the present disclosure.

FIG. 2 provides a further schematic view of an appliance system according to exemplary embodiments of the present disclosure.

FIG. 3 provides a flow chart illustrating a method of operating a consumer appliance according to exemplary embodiments of the present disclosure.

FIG. 4 provides a flow chart illustrating a method of operating a consumer appliance according to other exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

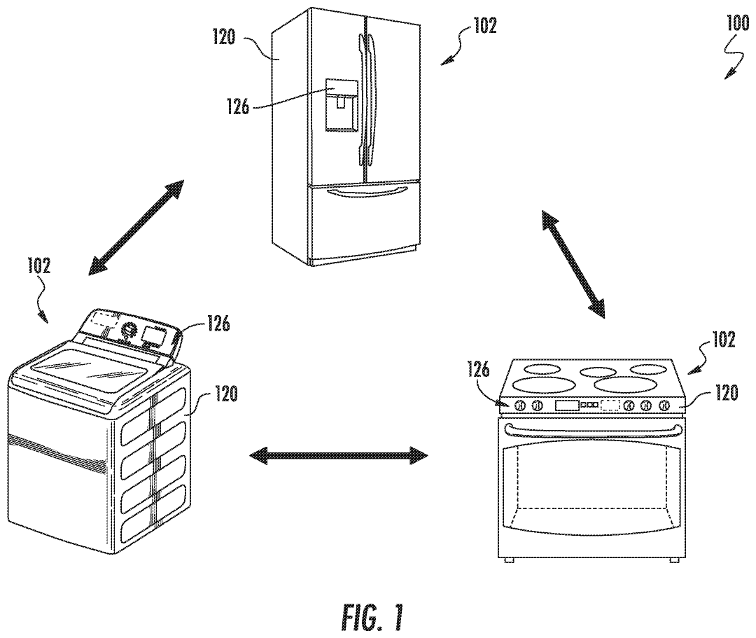

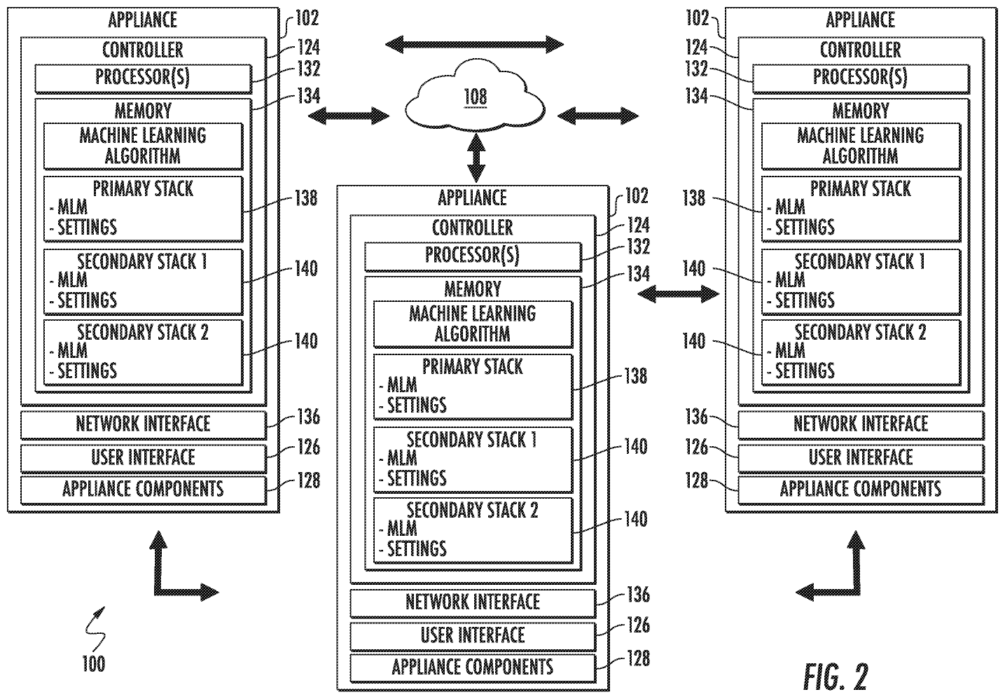

Turning now to the figures, FIGS. 1 and 2 provide different schematic views of a multi-appliance system 100 according to exemplary embodiments of the present disclosure. Generally, it is understood that such systems may be utilized to maintain or secure settings (e.g., data, algorithms, models, etc.) between multiple consumer appliances 102. In particular, consumer appliances 102 may be configured to communicate with each other (e.g., directly or indirectly) in order to aid or facilitate one or more inheritance operations, as will be described in detail below. As shown, each consumer appliance 102 can be communicatively coupled with a secondary network 108 and various nodes coupled with the secondary network 108, such as the other separate or remote consumer appliances 102. Additionally or alternatively, although secondary network 108 is shown (e.g., FIG. 2), one or more consumer appliances 102 can be communicatively coupled directly to each other via a suitable wired or wireless means, such as, for example, via physical wires, transceiving, transmitting, or receiving components.

It is noted that although consumer appliances 102 are shown as a refrigerator appliance, an oven appliance, and a washing machine appliance, additional or alternative embodiments may provide one or more different consumer appliances 102 (e.g., different types of appliances), such as a water heater appliance, microwave appliance, dishwashing appliance, dryer appliance, or any other suitable consumer appliance 102. Moreover, although three separate consumer appliances 102 are shown, additional or alternative embodiments may provide fewer appliances (e.g., two consumer appliances) or more appliances (e.g., four or more consumer appliances). Each consumer appliance 102 may be of the same type or of a different type.

As would be understood, each consumer appliance 102 generally includes a cabinet 120 and one or more appliance components 128 (e.g., compressor, heating element, motor, air blower, etc.) attached thereto for performing the predetermined functions of the corresponding consumer appliance 102 (e.g., cooling, heating, article washing, etc.). Such appliance components 128 are assembled in communication with a corresponding appliance controller 124 that is, for example, mounted on or within the cabinet 120 of the corresponding consumer appliance 102.

Along with appliance components 128, the appliance controller 124 may be in communication with one or more sensors (e.g., temperature sensors, pressure sensors, accelerometers, gyroscopes, etc.) attached to or within the corresponding cabinet 120 for detecting certain conditions (e.g., temperature, pressure, acceleration, rotation, etc.) of the corresponding consumer appliance 102 and permitting the appliance controller 124 to record one or more log sets (e.g., use-based data sets) of such conditions. In particular, such sensors may transmit one or more data signals to controller 124 that correspond to detected local conditions during operation of the corresponding appliance 102. Thus, appliance controller 124 may assemble and store log data sets of information regarding the conditions of operation for the corresponding consumer appliance 102 over one or more periods of time. Optionally, such log data sets (or detected conditions therein) may include or be adapted for a machine learning model (e.g., generated by a machine learning algorithm). Such a machine learning model may anticipate, predict, or prompt desired operation of the corresponding appliance based on, for example, past use of the consumer appliance 102. For instance, the machine learning model may determine when a user is likely to use the corresponding consumer appliance 102 and generate a prompt (e.g., audio or visual alert on/from a corresponding user interface 126).

In some embodiments, the machine learning model may be the result of training a machine learning algorithm programmed on controller 124. The training of such machine learning algorithms may be initiated or activated on controller 124 or the corresponding consumer appliance 102, generally. Additionally or alternatively, the machine learning algorithm may be a deep learning algorithm, convolutional neural network (CNN) algorithm, recurrent neural network (RNN) algorithm, reinforcement learning algorithm, deep Boltzmann machine (DBM) algorithm, etc., as would be understood. The training data for such machine learning algorithms may be applied from any suitable data source (e.g., gathered at the corresponding consumer appliance 102). For instance, the training data may be settings or user-experience data (e.g., received at a corresponding user interface 126), sensor data (e.g., received from one or more sensors of the corresponding consumer appliance 102), log data (e.g., received and subsequently recorded from one or more corresponding appliance components 128), etc. As the corresponding consumer appliance 102 continues to operate, the machine learning algorithm may continue to update or train the machine learning model (e.g., according to a predetermined time interval or schedule). Additionally or alternatively, as the machine learning model is updated, previous versions of the machine learning model may be deleted or replaced on the controller 124.

Separate from or in addition to appliance components 128, each appliance may include a control panel or user interface 126 having one or more inputs (e.g., positioned on an exterior of the corresponding cabinet 120). In various embodiments, the user interface 126 (and inputs thereof) may represent a general purpose I/O (“GPIO”) device or functional block. In additional or alternative embodiments, the user interface 126 (and inputs thereof) includes include one or more digital, analog, electrical, mechanical or electro-mechanical input devices including rotary dials, control knobs, push buttons, and touch pads. The user interface 126 may include a display component, such as a digital or analog display device designed to provide operational feedback to a user. The display component may also be a touchscreen capable of receiving a user input, such that the display component includes or is provided as inputs.

Generally, user interface 126 (and inputs or display component thereof) in communication with controller 124, such that input signals or display signals are transmitted to/from controller 124. For instance, inputs may be manipulated by a user to select or adjust operational setting (e.g., desired cooking temperature, desired cooling or chamber temperature, desired activation time, desired operational mode or cycle, etc.). In some such embodiments, controller 124 can record such settings in order to, for example, maintain steady operation of the appliance (e.g., at a given setting) or automatically adjust or predict operation of the appliance 102 (e.g., according to a machine learning algorithm or model). Such settings may, moreover, be assembled and recorded as one or more log data sets (e.g., a local use-based data set). Thus, a log data set may be provided with or as a plurality of selected settings or a machine learning model.

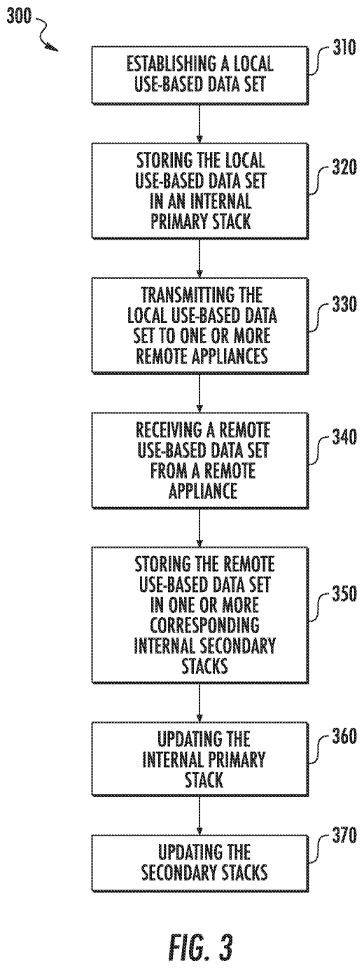

As illustrated in FIG. 3, each appliance controller 124 generally includes one or more processors 132 and one or more memory devices 134 (i.e., memory). The one or more processors 132 can be any suitable processing device (e.g., a processor core, a microprocessor, an ASIC, a FPGA, a microcontroller, etc.) and can be one processor or a plurality of processors that are operatively connected. The memory device 134 can include one or more non-transitory computer-readable storage mediums, such as RAM, ROM, EEPROM, EPROM, flash memory devices, magnetic disks, etc., and combinations thereof.

The memory devices 134 can store data and instructions that are executed by the processor 132 to cause consumer appliance 102 to perform various operations. For example, instructions could be instructions for directing activation of one or more appliance components 128 (e.g., based on settings provided by a user at the corresponding user interface 126). Instructions could further be for receiving/transmitting log data signals (e.g., use-based data sets, such as for the corresponding consumer appliances 102), recording use-based data as one or more data sets over time (e.g., within memory device 134), executing or updating a machine learning algorithm (e.g., to generate a machine learning model), etc. In certain embodiments, a use-based data set includes a machine learning model generated (e.g., by the corresponding processor) based on a machine learning algorithm and gathered use data or settings for a corresponding consumer appliance 102. In additional or alternative embodiments, a use-based data set includes plurality of user-selected settings of the corresponding consumer appliance 102. Optionally, the local use-based data set may include a reference or code indicating the appliance type of the corresponding consumer appliance 102.

In some embodiments, the memory device 134 of each consumer appliance 102 includes multiple discrete internal stacks for storing recorded use-based data sets. In particular, a primary stack 138 may be provided for storing a local use-based data set, which corresponds to the use or operation of that same consumer appliance 102 (i.e., primary appliance). Additionally or alternatively, one or more secondary stacks 140 may be provided for storing a remote use-based data set, which corresponds to the use or operation of another (e.g., wireless-connected) consumer appliance 102 (i.e., remote consumer appliance). Optionally, each stack 138, 140 may correspond to a different type of consumer appliance. For instance, on a refrigerator appliance, the primary stack 138 may correspond to the refrigerator appliance (e.g., primary appliance), a first secondary stack 140 may correspond to an oven appliance (e.g., first remote consumer appliance), and a second secondary stack 140 may correspond to a washing machine appliance (e.g., second remote consumer appliance). Similarly, on an oven appliance, the primary stack 138 may correspond to the oven appliance (e.g., primary appliance), a first secondary stack 140 may correspond to a washing machine appliance (e.g., first remote consumer appliance), and a secondary stack 140 may correspond to a refrigerator appliance (e.g., second remote consumer appliance).

Controller 124 includes a network interface 136 such that each consumer appliance 102 can connect to and communicate over one or more networks (e.g., network 108) with one or more network nodes. Network interface 136 can be an onboard component of controller 124 or it can be a separate, off board component. Controller 124 can also include one or more transmitting, receiving, or transceiving components for transmitting/receiving communications with other devices communicatively coupled across network 108. Additionally or alternatively, one or more transmitting, receiving, or transceiving components can be located off board controller 124.

Network 108 can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 108 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

In some embodiments, each consumer appliance 102 is in operable communication with one or more of the other consumer appliances 102 via network 108. For example, the consumer appliance 102 may be organized into peer-to-peer communication. In turn, controller 124 of one consumer appliance 102 may exchange signals (e.g., use-based data sets) with another (e.g., one or each other) separate or remote consumer appliance 102. Together, the consumer appliances 102 can form a local, wireless-connected appliance network (e.g., with or separate from network 108).

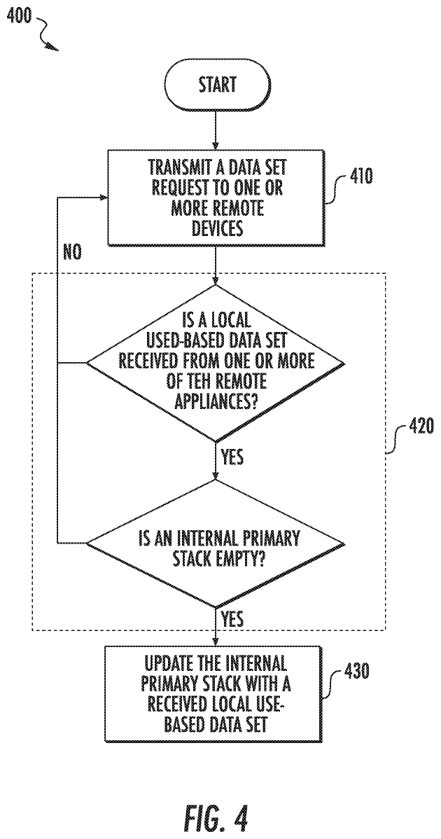

Referring now to FIGS. 3 and 4, various methods (e.g., method 300 and method 400) may be provided for use with system 100 in accordance with the present disclosure. In some embodiments, such as the exemplary embodiments illustrated by methods 300 and 400, all or some of the various steps of the method may be performed by the controller 124 of one consumer appliance 102 as part of an operation that the same controller 124 configured to initiate (e.g., an inheritance operation). During such methods, the controller 124 of one consumer appliance 102 may receive inputs and transmit outputs from various other portions of the system 100. For example, the controller 124 of one consumer appliance 102 may send signals to and receive signals from the controller(s) 124 of one or more of the other (i.e., remote) consumer appliances 102, as well as other suitable components. The present methods may advantageously permit use-based data sets to be shared between appliances. Additionally or alternatively, the present methods may advantageously permit a use-based data set of one appliance (e.g., unit) to be inherited by its replacement (e.g., replacement appliance unit). Moreover, such methods may advantageously be performed independently of any action or direction from a user or service professional. For example, a consumer appliances 102 (e.g., primary appliance) may regularly (e.g., according to a predetermined interval or schedule) initiate the below methods to transmit/receive use-based log sets to/from the other appliances (e.g., remote appliances). Furthermore, such methods may advantageously permit the safe transfer of data (e.g., without transmitting use-based data sets to a separate, internet-connected cloud server).

FIGS. 3 and 4 depict steps performed in a particular order for purpose of illustration and discussion. Those of ordinary skill in the art, using the disclosures provided herein, will understand that (except as otherwise indicated) the steps of any of the methods disclosed herein can be modified, adapted, rearranged, omitted, or expanded in various ways without deviating from the scope of the present disclosure.

Turning particularly to FIG. 3, at 310, the method 300 includes establishing a local use-based data set on a consumer appliance (e.g., the primary appliance). As described above, the local use-based data set may include or be provided as a machine learning model (e.g., generated on the corresponding consumer appliance according to a machine learning algorithm). In order to establish the local use-based data set, the consumer appliance may record discrete operations or actions prompted by a user (e.g., by engagement with one or more inputs of the consumer appliance) over time. Moreover, the recorded operations or actions may be fed into (i.e., applied to) a machine learning algorithm, as would be understood. Additionally or alternatively, the local use-based data set may include or be provided as a plurality of user-selected settings of the consumer appliance, as described also above. In order to establish the local use-based data set, the consumer appliance may record the current settings or commands prescribed by a user (e.g., by engagement with one or more inputs of the consumer appliance).

Although the local use-based data set may be established on the same consumer appliance (e.g., unit of consumer appliance) on which the local use-based data set is generated, additional or alternative embodiments may establish a local use-based data set that originates on a separate unit from the unit on which the use-based data set is established at 310. For instance, an old/replaced unit may generate the local use-based data set while a new/replacement unit of consumer appliance—the new/replacement unit being the same type of appliance as the old/replaced unit—is the primary appliance that establishes the local use-based data set. In some embodiments, 310 includes first receiving the local use-based data set from a wirelessly-connected remote appliance (e.g., prior to any of the below steps). Subsequently, 310 may include adopting the local use-based data set (e.g., in response to receiving the local use-based data set). In particular, the receiving consumer appliance (e.g., new/replacement unit of consumer appliance) may operate according to the machine learning model or plurality of user-selected settings of the received local use-based data set. Thus, 310 may provide for inheriting the local use-based data set from an old/replaced unit of consumer appliance.

At 320, the method 300 includes storing the local use-based data set in an internal primary stack. Specifically, the memory of the primary appliance may include an internal primary stack, as described above. Thus, the memory may provide a virtual container or slot (i.e., the internal primary stack) in which the local use-based data set may be copied and stored (or subsequently deleted from).

At 330, the method 300 includes transmitting the local use-based data set to one or more remote appliances. For instance, the local use-based data set may be transmitted from the primary appliance to a first remote appliance or a second remote appliance. The local use-based data set (e.g., copies thereof) may be sent to multiple remote appliances (e.g., the first remote appliance and the second remote appliance) simultaneously or, alternatively, at separate times. The transmission of 330 may be initiated according to a predetermined time interval or schedule. Additionally or alternatively, the transmission of 330 may be initiated in response to a data set request from one or more remote appliances. Optionally, the local use-based data set may be transmitted together or in tandem with any previous or current remote use-based data sets (e.g., currently stored within the internal secondary stacks of the primary appliance, as described below).

The one or more remote appliances may be wireless-connected to (i.e., in wireless communication with) the consumer appliance of 310 (i.e., the primary appliance transmitting the local use-based data set at 330). Thus, as described above, the local use-based data set may be wirelessly transmitted (e.g., as a data signal) between multiple discrete appliances (e.g., different units of different types). The local use-based data set may be transmitted directly to the wirelessly-connected remote appliance(s) or, alternatively, through an intermediate network of devices (e.g., the internet).

At 340, the method 300 includes receiving a remote use-based data set from a remote appliance (e.g., all or less than all of the wirelessly-connected remote appliances).

In some embodiments, 340 includes receiving a first remote use-based data set from the first remote appliance. The first remote use-based data set may include, for example, a machine learning model or plurality of user-selected settings corresponding to the first remote appliance. Optionally, the first remote use-based data set may include a reference or code indicating the appliance type of the first remote appliance.

In additional or alternative embodiments, 340 includes receiving a second remote use-based data set from the second remote appliance (e.g., simultaneously with or separately from the first remote use-based data set). The second remote use-based data set may include, for example, a machine learning model or plurality of user-selected settings corresponding to the second remote appliance. Optionally, the second remote use-based data set may include a reference or code indicating the appliance type of the second remote appliance.

Thus, the remote appliances may transmit use-based data sets to the primary appliance, similar to the transmission of the primary appliance at 330.

At 350, the method 300 includes storing the remote used based data set(s) in one or more corresponding internal secondary stacks. Specifically, the memory of the primary appliance may include one or more internal secondary stacks for storing use-based data sets from the remote appliance(s), as described above. Thus, the memory may provide discrete virtual containers or slots (i.e., the internal secondary stacks) in which the local use-based data set may be copied and stored (or subsequently deleted from). Moreover, the primary appliance may provide redundant storage for the use-based data sets of the remote appliance(s).

In some embodiments, 350 includes storing the received first remote use-based data set in a first internal secondary stack. In additional or alternative embodiments, 350 includes storing the received secondary remote use-based data set in a second internal secondary stack.

At 360, the method 300 includes updating the primary stack. For instance, over time or with subsequent use of the primary appliance, a machine learning model or user-selected settings of the primary appliance may change. In turn, the local use-based data set stored and transmitted at 320 and 330, respectively, may become outdated (e.g., as a previous local use-based data set). In turn, an updated local use-based data set of or within the primary appliance may be detected. Optionally, the updated local use-based data set may be detected in response to a change in the machine learning model or user-directed settings. Additionally or alternatively, the updated local use-based data set may be detected according to a predetermined update interval in which the local use-based data set is updated.

Subsequent to detection of the updated local use-based data set, 360 may include replacing the previous local use-based data set (e.g., of 330) with the updated use-based data set in the internal primary stack. In some such embodiments, the previous local use-based data set is deleted while the updated local use-based data set is inserted or copied into the internal primary stack. Thus, the internal primary stack may maintain a current or regularly-updated version of a local data set for the primary appliance. Moreover, the local data set may be maintained internally within the same primary appliance.

At 370, the method 300 includes updating the secondary stacks. For instance, over time or with subsequent use of the remote appliances, a machine learning model or user-selected settings of the remote appliances may change. In turn, the remote use-based data sets received and stored at 340 and 350, respectively, may become outdated (e.g., as previous remote use-based data sets). In turn, an updated remote use-based data sets within the primary appliance may be detected. Optionally, the updated remote use-based data set may be detected in response to receiving a new remote use-based data set (e.g., from a corresponding remote appliance) including in the machine learning model or user-directed settings. Additionally or alternatively, the updated remote use-based data set may be detected according to a predetermined update interval in which the remote use-based data sets are updated.

Subsequent to detection of the updated remote use-based data set(s), 370 may include replacing the previous remote use-based data set(s) (e.g., of 350) with the updated use-based data set(s) in the internal secondary stack. In some such embodiments, the previous remote use-based data set is deleted while the updated remote use-based is inserted or copied into the corresponding, internal secondary stack (e.g., first internal secondary stack or second internal secondary stack). Thus, each internal secondary stack may maintain a current or regularly-updated version of a remote data set for the wirelessly-connected remote appliances. Moreover, the remote data set(s) (e.g., data sets of other consumer appliance units and types) may be maintained internally within the primary appliance.

Turning particularly to FIG. 4, at 410, the method 400 includes transmitting a data set request to one or more remote appliances. In some embodiments, such a data set request is prompted according to a predetermined interval or schedule. In additional or alternative embodiments, such a data set request is prompted in response to detecting a request event, such as receiving power during an initial startup of the consumer appliance (e.g., primary appliance) or following a prolonged period without power. When received by a remote appliance (e.g., a discrete appliance that is wirelessly-connected to the primary appliance), the remote appliance may be prompted to transmit a use-based data set to the primary appliance that corresponds to that same type of appliance. The use-based data set corresponding to the primary appliance may be transmitted alone or, alternatively, with one or more use-based data sets that correspond to one or more remote appliances (e.g., different appliance units of different appliance types).

At 420, the method 400 includes determining a local data set status. In particular, 420 determines if a local data set is received from one or more (e.g., wirelessly-connected) remote appliances. If a local use-based data set (i.e., data set corresponding to same type of appliance as the primary appliance) is received, 420 may determine if an internal primary stack is empty. In other words, it may be determined if a local use-based data set for the primary appliance is already present and stored internally on the primary appliance. If no local use-based data set is received or is absent from the primary stack, the method 400 may return to 410 (e.g., following a set delay period). By contrast, if a local use-based data set is received and the primary stack is empty, the method 400 may proceed to 430.

At 430, the method 400 includes updating the primary stack with the received, local use-based data set of 420. In other words, the local use-based data set of 420 may be stored within the internal primary stack. Subsequently, the local use-based data set in the primary stack may be adopted by the primary appliance (e.g., in response to receiving the local use-based data set). In particular, the primary appliance may operate according to a machine learning model or plurality of user-selected settings of the received local use-based data set.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a consumer appliance comprising:
establishing a local use-based data set of the consumer appliance;
storing the local use-based data set in an internal primary stack;
transmitting the local use-based data set to a first wirelessly-connected remote appliance of a specific appliance type;
receiving a remote use-based data set from the first wirelessly-connected remote appliance;
storing the remote use-based data set in an internal secondary stack in the consumer appliance, the internal secondary stack corresponding to the specific appliance type of the first wirelessly-connected remote appliance; and
transmitting the local use-based data set to a second wirelessly-connected remote appliance, the second wirelessly-connected remote appliance being a different appliance type from the consumer appliance and the first wirelessly-connected remote appliance,
wherein the local use-based data set comprises a machine learning model corresponding to the consumer appliance, and
wherein the remote use-based data set comprises a machine learning model corresponding to the first wirelessly-connected remote appliance.

2. The method of claim 1, wherein the local use-based data set further comprises a plurality of user-selected settings of the consumer appliance.

3. The method of claim 1, wherein establishing the local use-based data set comprises:
receiving, prior to storing the local use-based data set, the local use-based data set from the first wirelessly-connected remote appliance; and
adopting the local use-based data set in response to receiving the local use-based data set.

4. The method of claim 1, wherein transmitting the local use-based data set is initiated according to a predetermined time interval.

5. The method of claim 1, wherein the local use-based data set is transmitted directly to the first wirelessly-connected remote appliance.

6. The method of claim 1, wherein the remote use-based data set is a previous remote use-based data set of the first wirelessly-connected remote appliance, and wherein the method further comprises:
receiving an updated remote use-based data set from the first wirelessly-connected remote appliance subsequent to the previous remote use-based data set; and
replacing the previous remote use-based data set with the updated remote use-based data set in the internal secondary stack.

7. (canceled)

8. The method of claim 1, wherein the internal secondary stack is a first internal secondary stack, and wherein the method further comprises:
receiving a second remote use-based data set from the second wirelessly-connected remote appliance; and
storing the second remote use-based data set in a second internal secondary stack.

9. The method of claim 1, wherein the local use-based data set is a previous local use-based data set of the consumer appliance, and wherein the method further comprises:
detecting an updated local use-based data set within the consumer appliance;
replacing the previous local use-based data set with the updated use-based data set in the internal primary stack; and
transmitting the updated local use-based data set to the first wirelessly-connected remote appliance.

10. A consumer appliance comprising:
a cabinet;
a user input positioned on an exterior of the cabinet; and
a controller mounted to the cabinet, the controller being configured to initiate an inheritance operation, the inheritance operation comprising
establishing a local use-based data set of the consumer appliance,
storing the local use-based data set in an internal primary stack within the controller,
transmitting the local use-based data set to a first wirelessly-connected remote appliance,
receiving a remote use-based data set from the first wirelessly-connected remote appliance,
storing the remote use-based data set in an internal secondary stack within the controller, the internal secondary stack corresponding to the specific appliance type of the first wirelessly-connected remote appliance, and
transmitting the local use-based data set to a second wirelessly-connected remote appliance, the second wirelessly-connected remote appliance being a different appliance type from the consumer appliance and the first wirelessly-connected remote appliance,
wherein the local use-based data set comprises a machine learning model corresponding to the consumer appliance, and
wherein the remote use-based data set comprises a machine learning model corresponding to the first wirelessly-connected remote appliance.

11. The consumer appliance of claim 10, wherein the local use-based data set further comprises a plurality of user-selected settings of the consumer appliance.

12. The consumer appliance of claim 10, wherein establishing the local use-based data set comprises
receiving, prior to storing the local use-based data set, the local use-based data set from the first wirelessly-connected remote appliance, and
adopting the local use-based data set in response to receiving the local use-based data set.

13. The consumer appliance of claim 10, wherein transmitting use-based data set is initiated according to a predetermined time interval.

14. The consumer appliance of claim 10, wherein the local use-based data set is transmitted directly to the first wirelessly-connected remote appliance.

15. The consumer appliance of claim 10, wherein the remote use-based data set is a previous remote use-based data set of the first wirelessly-connected remote appliance, and wherein the inheritance operation further comprises
receiving an updated remote use-based data set from the first wirelessly-connected remote appliance subsequent to the previous remote use-based data set, and
replacing the previous remote use-based data set with the updated remote use-based data set in the internal secondary stack.

16. (canceled)

17. The consumer appliance of claim 10, wherein the internal secondary stack is a first internal secondary stack, and wherein the inheritance operation further comprises
receiving a second remote use-based data set from the second wirelessly-connected remote appliance, and
storing the second remote use-based data set in a second internal secondary stack within the controller.

18. The consumer appliance of claim 10, wherein the local use-based data set is a previous local use-based data set of the consumer appliance, and wherein the inheritance operation further comprises
detecting an updated local use-based data set within the consumer appliance,
replacing the previous local use-based data set with the updated use-based data set in the internal primary stack, and
transmitting the updated local use-based data set to the first wirelessly-connected remote appliance.

19. A method of operating a consumer appliance comprising:
establishing a previous local use-based data set of the consumer appliance;
storing the previous local use-based data set in an internal primary stack;
transmitting the previous local use-based data set to a first wirelessly-connected remote appliance of a specific appliance type;
receiving a remote use-based data set from the first wirelessly-connected remote appliance;
storing the remote use-based data set in an internal secondary stack in the consumer appliance, the internal secondary stack corresponding to the specific appliance type of the first wirelessly-connected remote appliance; and
transmitting the previous local use-based data set to a second wirelessly-connected remote appliance, the second wirelessly-connected remote appliance being a different appliance type from the consumer appliance and the first wirelessly-connected remote appliance;
detecting an updated local use-based data set within the consumer appliance;
replacing the previous local use-based data set with the updated use-based data set in the internal primary stack;
transmitting the updated local use-based data set to the first wirelessly-connected remote appliance; and
transmitting the updated local use-based data set to the second wirelessly-connected remote appliance
wherein the previous local use-based data set comprises a previous machine learning model corresponding to the consumer appliance,
wherein the updated local use-based data set comprises an updated machine learning model corresponding to the consumer appliance, and
wherein the remote use-based data set comprises a machine learning model corresponding to the first wirelessly-connected remote appliance.
